(19) United States
(12) Patent Application Publication
(10) Pub. No.: US 2008/0307416 A1
(43) Pub. Date: Dec. 11, 2008

(54) DEVICE MANAGEMENT APPARATUS, DEVICE MANAGEMENT METHOD, AND STORAGE MEDIUM

(76) Inventors: Motomi INOUE, Sapporo-shi (JP); Youhei Takeyama, Sapporo-shi (JP); Masami Yoshida, Chitose-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/136,898

(22) Filed: Jun. 11, 2008

(30) Foreign Application Priority Data
Jun. 11, 2007 (JP) 2007-154299

(51) Int. Cl. G06F 9/46

(52) U.S. Cl. 718/100

(57) ABSTRACT

A management apparatus that promotes productivity of management of a plurality of devices and of a plurality of functions of the device. The management apparatus for managing a plurality of functions for use in a device by a user, wherein each function has one or more functional elements, the apparatus including a first memory module that stores correspondence data describing a relationship between a functional element and unit configuration information of the device, the unit configuration information indicating units of the device used by the functional element, a second memory module that stores use authority data corresponding to the user, a management module that selects an available function based on the correspondence data and the use authority data, and sends the functional elements corresponding to the selected function to the device.

### CROSS REFERENCE TO RELATED APPLICATIONS

This application is based upon and claims priority under 35 U.S.C. §119 from Japanese Patent Application No. 2007-154299, filed Jun. 11, 2007, the entire contents of which are hereby incorporated by reference.

### BACKGROUND OF THE INVENTION

1. Field of the Invention

The present invention generally relates to a device management apparatus, a device management method, and a storage medium, and more particularly, to a device management apparatus and a device management method that manages a plurality of functions of a device, wherein the device provides use of the functions to the user.

2. Description of the Related Art

In the related art, a multifunction device has a plurality of functions (such as a copy function, a printer function, a scanner function, or a fax function) that are embedded in the device originally, manages the use authority of each function, and manages charging for the use of the function by each user. (See, for example, Japanese Laid-Open Patent Application No. 2006-18654.)

On the other hand, recently in the field of multifunction devices, to raise the further convenience of the user, some devices can add a new function to the device by modification of the device.

However, in this related art, a management of the use authority of the user for the functions becomes complicated when the functions are changed frequently.

### SUMMARY OF THE INVENTION

Embodiments of the present invention provide a management apparatus, a management method, and a storage medium containing program code for causing a computer to perform the management method that solves or reduces one or more problems caused by the limitations and disadvantages of the related art, and promotes productivity of management of a plurality of devices and of a plurality of functions of the device.

In the present invention, a function has plurality of functional elements. Hereinafter a function is called a “scenario”, and a functional element is called an “activity”. The scenario includes a combination of a plurality of the activities to be performed on the device. The present invention may be applied to an apparatus managing a device such as a printer, a copier, a fax, or a scanner.

### BRIEF DESCRIPTION OF THE DRAWINGS

FIG. 1 is a diagram showing a configuration of an exemplary management system according to an embodiment of the present invention;

FIG. 2 is a diagram showing a detailed configuration of an exemplary management system according to an embodiment of the present invention;

FIG. 3 is a diagram showing a configuration of an exemplary hardware of the management apparatus;

FIG. 4 is a sequence chart showing an exemplary mutual certification process between a management apparatus and a device according to an embodiment of the present invention;

FIG. 5 is a sequence chart showing an exemplary device configuration information acquisition process according to an embodiment of the present invention;

FIG. 6 is a sequence chart showing an exemplary user login process according to an embodiment of the present invention;

FIG. 7 is a sequence chart showing one exemplary available activity setup process according to an embodiment of the present invention;

FIG. 8 is a diagram showing one exemplary activity information list of the management apparatus;

FIG. 9 is a diagram showing an exemplary use restriction management DB of the management apparatus;

FIG. 10 is a sequence chart showing a second exemplary available activity setup process according to an embodiment of the present invention;

FIG. 11 is a diagram showing a second exemplary activity information list of the management apparatus;

FIG. 12 is a sequence chart showing a third exemplary available activity setup process according to an embodiment of the present invention;

FIG. 13 is a diagram showing a third exemplary activity information list of the management apparatus;

FIG. 14 is a sequence chart showing an exemplary charge process according to an embodiment of the present invention;

FIG. 15 is a diagram showing an exemplary use management DB of the management apparatus;

FIG. 16 is a diagram showing an exemplary activity management DB of the management apparatus;

FIG. 17 is a sequence chart showing an exemplary activity information synchronous process according to an embodiment of the present invention;

FIG. 18 is a sequence chart showing an exemplary activity purchase process according to an embodiment of the present invention;

FIG. 19 is a diagram showing an exemplary of a certification table the activity providing device;

FIG. 20 is a sequence chart showing an exemplary purchased activity automatic update process according to an embodiment of the present invention;

FIG. 21 is a diagram showing an exemplary scenario management DB of the management apparatus;

FIG. 22 is a diagram showing a user interface of the user interface device, for activity use setting for a general user;

FIG. 23 is a diagram showing a user interface of the user interface device, for activity use setting for a system manager;

FIG. 24 is a diagram showing a user interface of the user interface device, for activity adding for a system manager;

FIG. 25 is a diagram showing a user interface of the user interface device, for scenario use setting for a general user;

FIG. 26 is a diagram showing a user interface of the user interface device, for scenario use setting for a system manager; and

FIG. 27 is a diagram showing a user interface of the user interface device, for scenario setting for a system manager.

### DESCRIPTION OF THE PREFERRED EMBODIMENTS

Preferred embodiments of the present invention are described below with reference to the accompanying drawings.

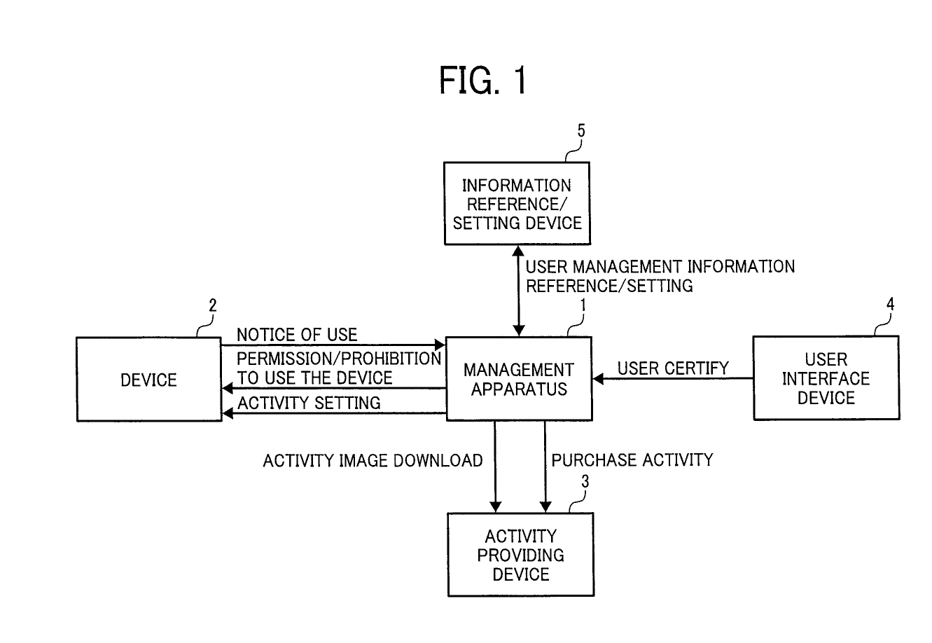

FIG. 1 is a diagram showing a configuration of an exemplary management system according to an embodiment of the present invention.

Referring to FIG. 1, the management system includes a device management apparatus 1, a device 2 (management object), an activity providing device 3, a user interface device 4, and an information reference/setting device 5.

The device management apparatus 1 receives a notice of use of an activity of the user from apparatus 2. The device management apparatus 1 demands a permission/prohibition of using the device, and demands a setting of the activities.

The device management apparatus 1 purchases activities from an activity-providing device 3, and downloads the activity data (activity files) from the activity-providing device 3. The device management apparatus 1 acquires a user ID from the user interface device 4 and certifies the user.

The device management apparatus 1 receive a request of certification information, and receives a setting/reference request of user management information from the information reference/setting device 5. The device management apparatus 1 performs processing based on the requests.

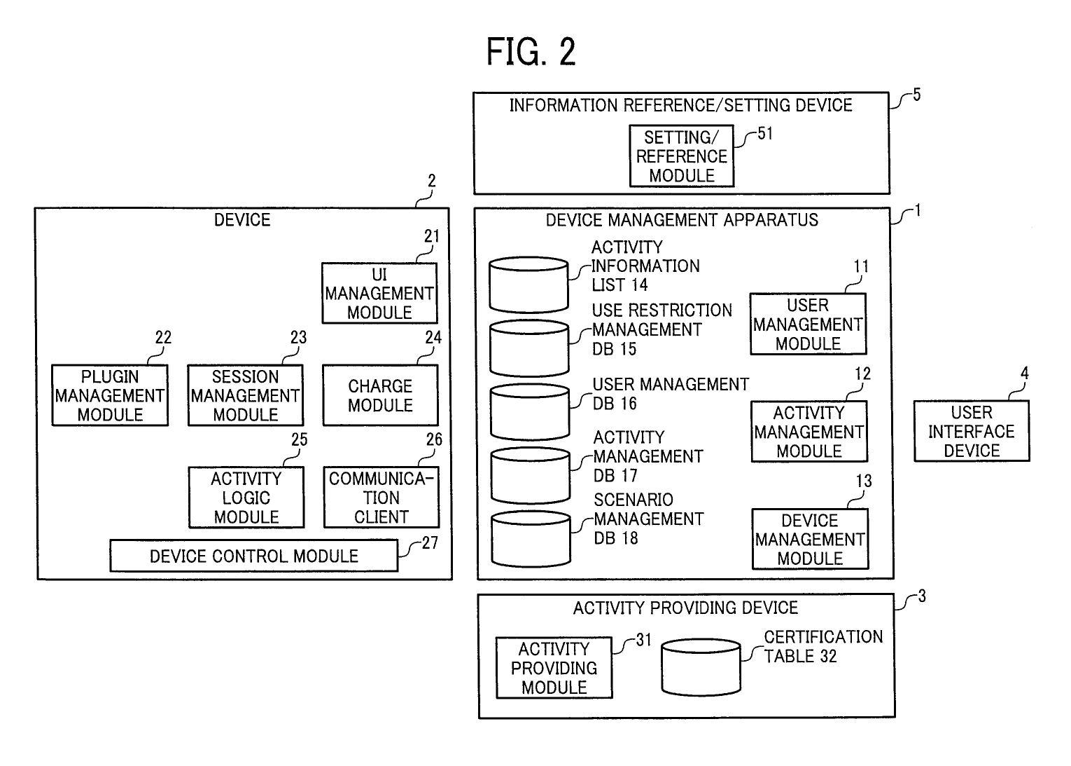

FIG. 2 is a diagram showing a detailed configuration of an exemplary management system according to an embodiment of the present invention.

Referring to FIG. 2, the device management apparatus 1 includes a user management module 11, an activity management module 12, a device management module 13, an activity information list 14, a use restriction management DB 15, a user management DB 16, an activity management DB 17, and a scenario management DB 18. The device 2 includes a user interface management module 21, a plugin management module 22, a session management module 23, a charge module 24, an activity logic module 25, a communication client 26, and a device control module 27. The activity-providing device 3 includes an activity providing module 31 and a certification table 32. The information reference/setting device 5 includes setting/reference module 51.

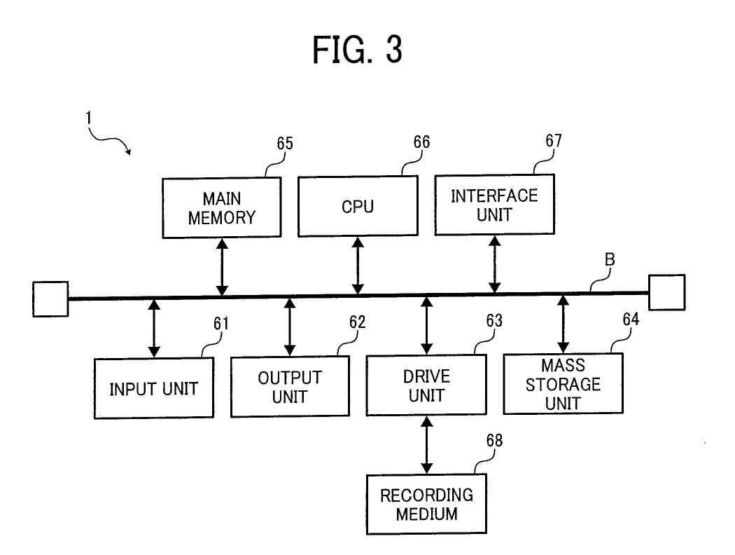

FIG. 3 is a diagram showing a configuration of exemplary hardware of the management apparatus 1.

Referring to FIG. 3, the management apparatus 1 includes an input unit 61, an output unit 62, a drive unit 63, a mass storage unit 64, a main memory 65, a CPU 66, and an interface unit 67, connected to a bus B mutually.

Input device 61 includes, for example, a keyboard or a mouse, to input various signals. The output device 62 may be a display unit to display various windows or data. The interface device 67 includes, for example, a modem or a LAN card to connect to the network.

A device management program of this invention is at least a program to control the device management apparatus 1. The device management program is provided, for example, by being downloaded from the network or obtained by a distributed recording medium 68. Recording medium 68, on which is recorded the device management program, may be a various types of medium, for example, a ROM, a flash memory, a CD-ROM, a flexible disk, or an MO disk. The mass storage unit 64 stores an installed device management program and stores necessary files or data.

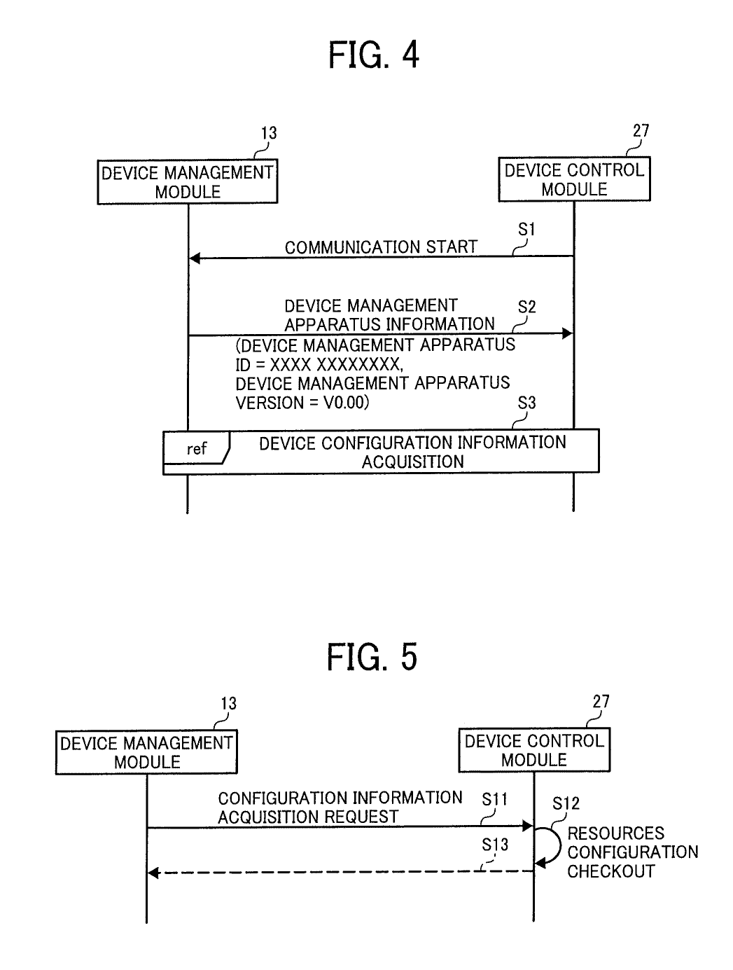

FIG. 4 is a sequence chart showing an exemplary mutual certification process between the management apparatus and the device according to an embodiment of the present invention.

Referring to FIG. 4, the device control module 27 of the device 2 transmits a communication start signal for the device management module 13 of device management apparatus 1 (S 1). The device management module 13 transmits device management apparatus information to device control module 27 when receiving the communication start signal (S2). The device management apparatus information may include device management apparatus ID, and a device management apparatus version. The device management module 13 acquires apparatus configuration information from device control module 27 in a procedure shown in FIG. 5 (S3). In addition, step S3 may be skipped at the time of mutual certification processing if it performed every time at the login of the user.

FIG. 5 is a sequence chart showing an exemplary device configuration information acquisition process according to an embodiment of the present invention.

Referring to FIG. 5, the device management module 13 sends acquisition request of configuration information from the device control module 27 of the device 2 (S11). The device control module 27 checks resources configuration of the apparatus 2 (S12). The device control module 27 notifies the configuration information, which was checked in step 12, to the device management module 13, responding to the acquisition request (S13). The configuration information may include hardware resources information, which identifies hardware units of the device, for example, a print unit, a scan unit, a two-sided printing unit, or other optional units. In addition, the configuration information may include software information, for example, image processing software, or image storing software to the mass storage.

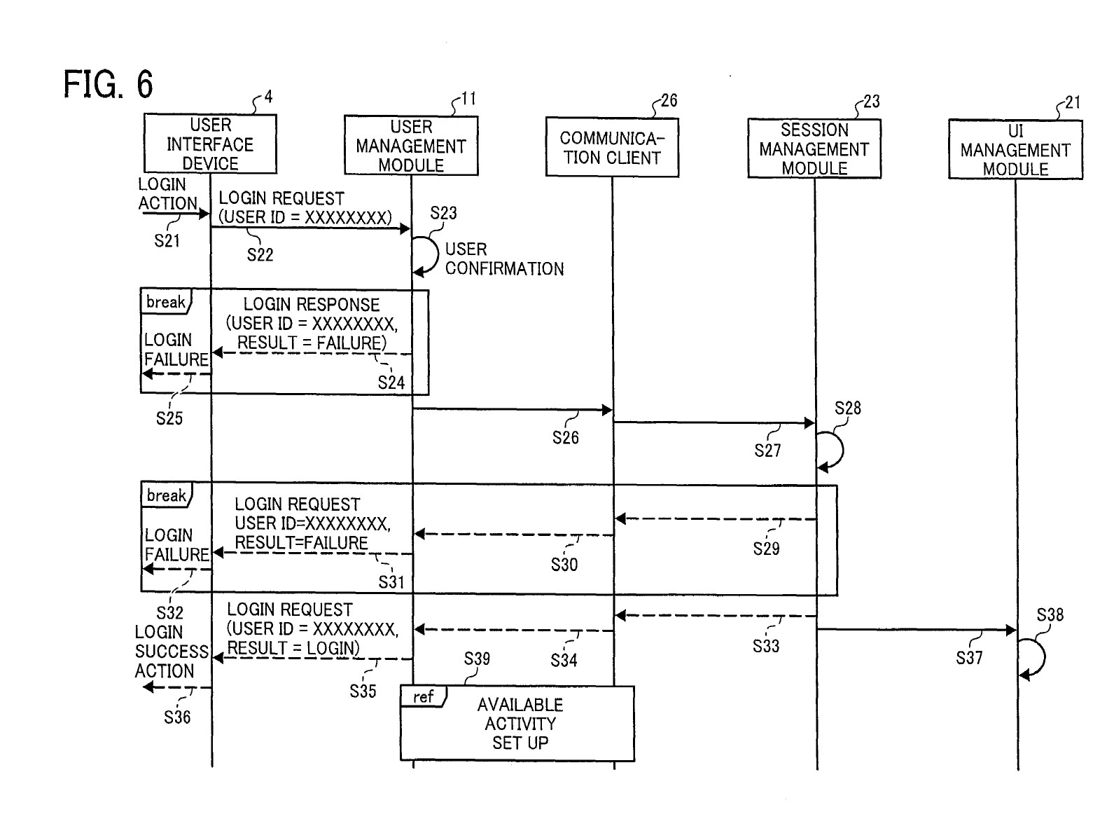

FIG. 6 is a sequence chart showing an exemplary user login process according to an embodiment of the present invention.

Referring to FIG. 6, the user interface device 4 takes a login action from the user (S21). The login action may be, for example, holding a user ID recorded chip card up to the user interface device 4 to be read, or inputting a user ID and password. The user interface device 4 acquires the user ID. The user interface device 4 performs a login request including the user ID to the user management module 11 of the device management apparatus 1 (S22).

The user management module 11 confirms that whether the user who performed a login action is a registered user or not, using the user ID included in the login request (S23).

When the user is not a registered user, responding to login action, the user management module 11 notifies login failure to the user interface device 4 (S24). The user interface device 4 notifies the login failure to the user (S25).

When the user is a registered user, user management module 11 notifies the beginning of use of the user to the communication client 26 of the apparatus 2 (S26). The communication client 26 sends a requirement of a user certification to the session management module 23, which the requirement including the user ID (S27).

The session management module 23, using the user ID included in the login request, confirms whether the user who performed a login action is an entitled user to use the device 2 (S28).

When the user is not an entitled user, the session management module 23 notifies the communication client 26 of use impossibility in the requirement reply (S29). The communication client 26 performs the user state notice, which notifies the user management module 11 of the login impossibility of the user (S30). The user management module 11 notifies the user interface device 4 of login impossibility (S29), and, the user interface device 4 notifies the login failure to the user (S32).

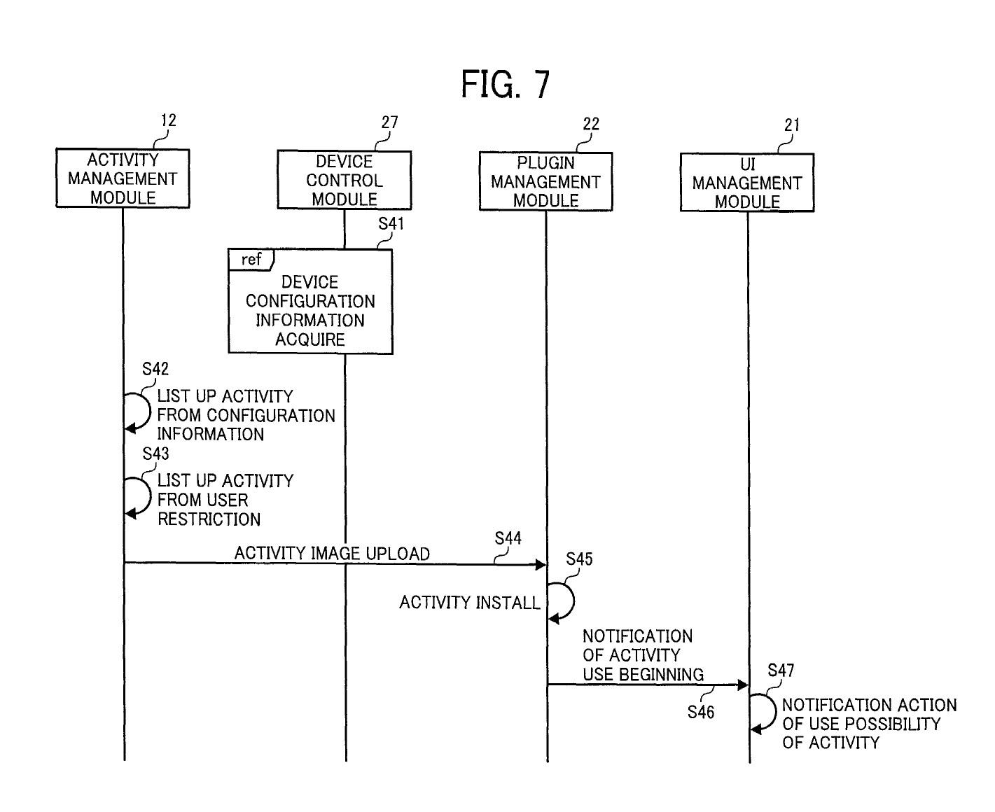

When the user is an entitled user, session management module 23 notifies the communication client 26 of use possibility in the requirement reply (S33), the communication client 26 notifies the user management module 11 of the login possibility of the user (S34), the user management module 11 notifies the user interface device 4 of login possibility (S35), and the user interface device 4 notifies the login success to the user (S36). In addition, the session management module 23 performs a notice of user login including the user ID for the UI management module 21 (S37). The UI management module 21 performs an action (a login success action), for example, changing a panel indication for indicating the success of the login, according to the notice of user login (S38). Furthermore, device 2 sets up the available activity as described below with respect to FIG. 7 (S39).

FIG. 7 is a sequence chart showing one exemplary available activity setup process according to an embodiment of the present invention.

Referring to FIG. 7, the available activity setup process is performed, which includes downloading the activity data at the time of the purchase of the activities, and maintaining all available activity data in the inside of the device management apparatus 1. The device management module 13 acquires the device configuration information from the device control module 27 in the procedure that shown in FIG. 5. In addition, the procedure of step S41 is unnecessary if the device configuration information has already been acquired.

The activity management module 12 of the device management apparatus 1 lists the activities (including an activity set) from the activity information list maintained in the management apparatus 1 and from the configuration information notified from the device control module 27, wherein the activities can be used by the device 2 (management object device) (S42).

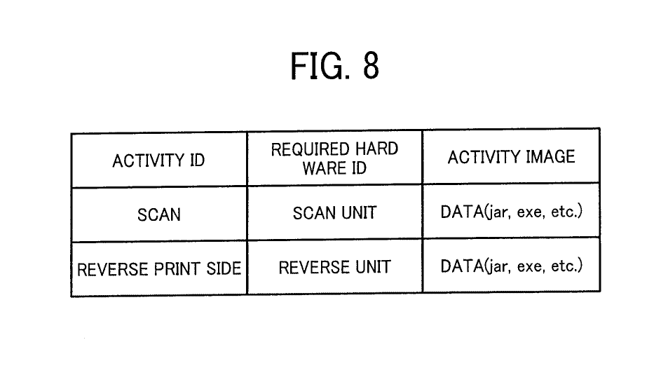

FIG. 8 is a diagram showing one exemplary activity information list of the management apparatus.

Referring to FIG. 8, the activity information list includes activity ID in correspondence with required hardware (configuration) ID, and downloaded activity data.

Returning to FIG. 7, the activity management module 12 lists the activities, which can be used by the device 2, from the configuration information notified from the device control module 27 (S42). The activity management module 12 narrows down the activities, which can be used by the logged-in user from the activities listed in step S42, using the use restriction management DB 15 (S43).

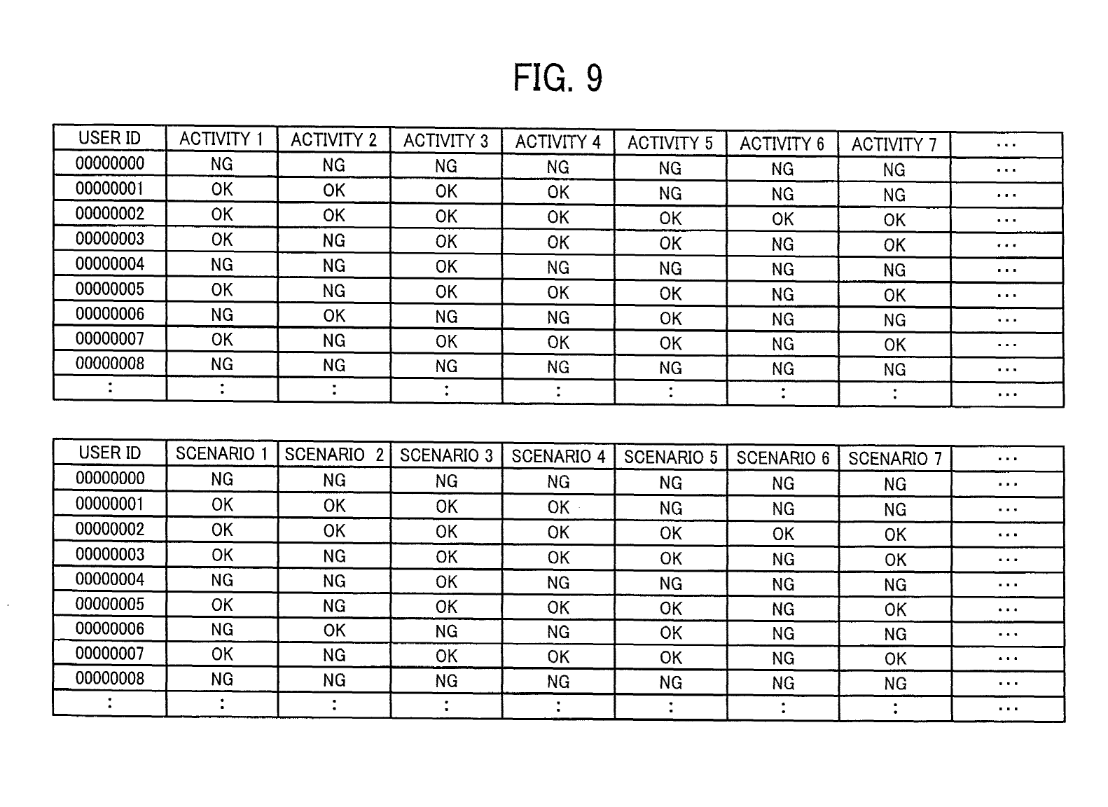

FIG. 9 is a diagram showing an exemplary use restriction management DB of the management apparatus.

Referring to FIG. 9, the use restriction management DB 15 showing which activities and scenarios each user can use.

Returning to FIG. 7, the activity management module 12 uploads the activity image of the activity, which the user who logged in the plugin management module 22 can use (S44). The plugin management module 22 installs the uploaded activity image from the activity management module 12 (S45). The plugin management module 22 notifies the UI management module 21 of an activity use beginning (S46). The UI management module 21 performs a notification action of use possibility of the activity, for example, changing a panel indication of the UI management module 21 (S47).

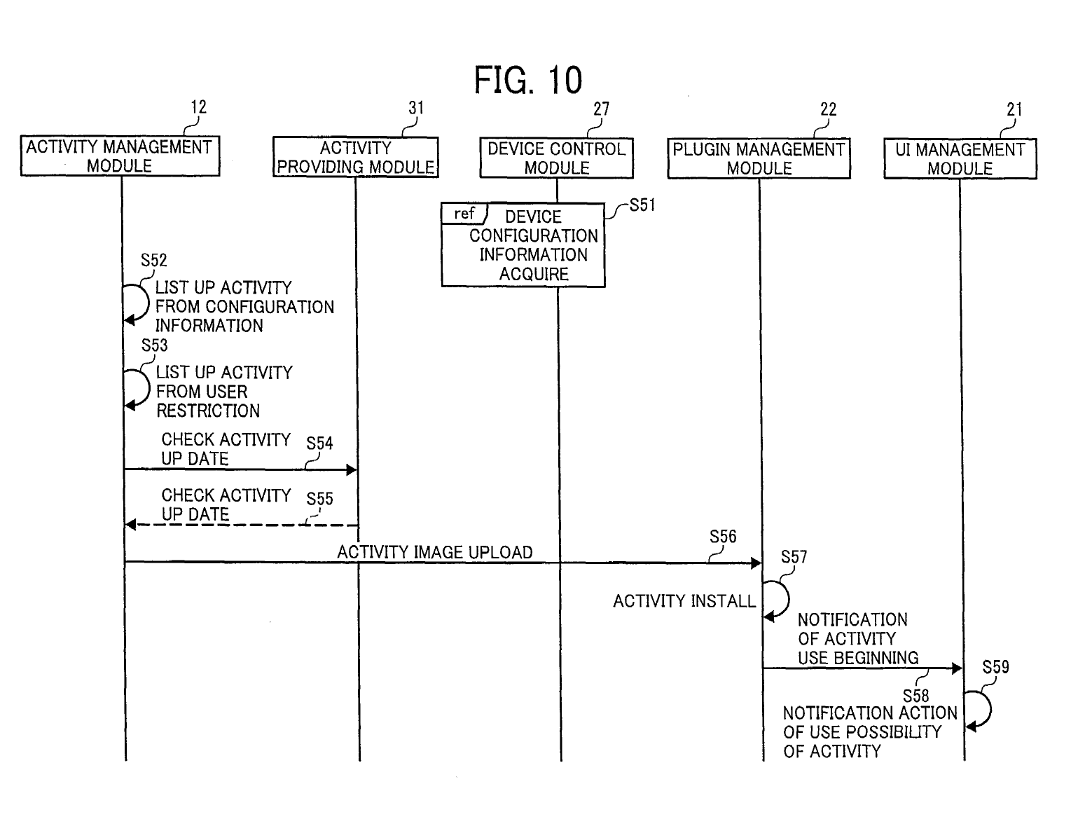

FIG. 10 is a sequence chart showing a second exemplary available activity setup process according to an embodiment of the present invention.

Referring to FIG. 10, the device management apparatus 1 acquires the activity image from the activity providing device 3. Since the sequence chart of FIG. 10 is the same as FIG. 7 except for some parts, an explanation about the common parts will be skipped. The sequence of steps S51˜S53, and S56˜S59 is similar to steps S41˜S43 and S44˜S47 respectively of FIG. 7.

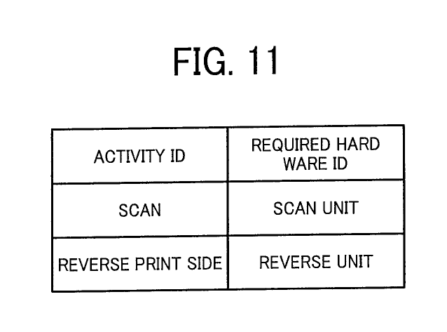

The activity management module 12 of device management apparatus 1 holds an activity information list such as shown in FIG. 11.

FIG. 11 is a diagram showing a second exemplary activity information list of the management apparatus, wherein the activity information list includes activity ID in correspondence with required hardware (configuration) ID.

Returning to FIG. 10, the activity management module 12 requests the activity image to the activity providing module 31 of the activity providing device 3, wherein the activity image of the activity listed up in step S53 (S54), and acquires the activity image from the activity providing module 31 (S55). Because the activity management module 12 acquires the activity on demand, the activity management module 12 does not need to necessarily save an activity inside, in this embodiment.

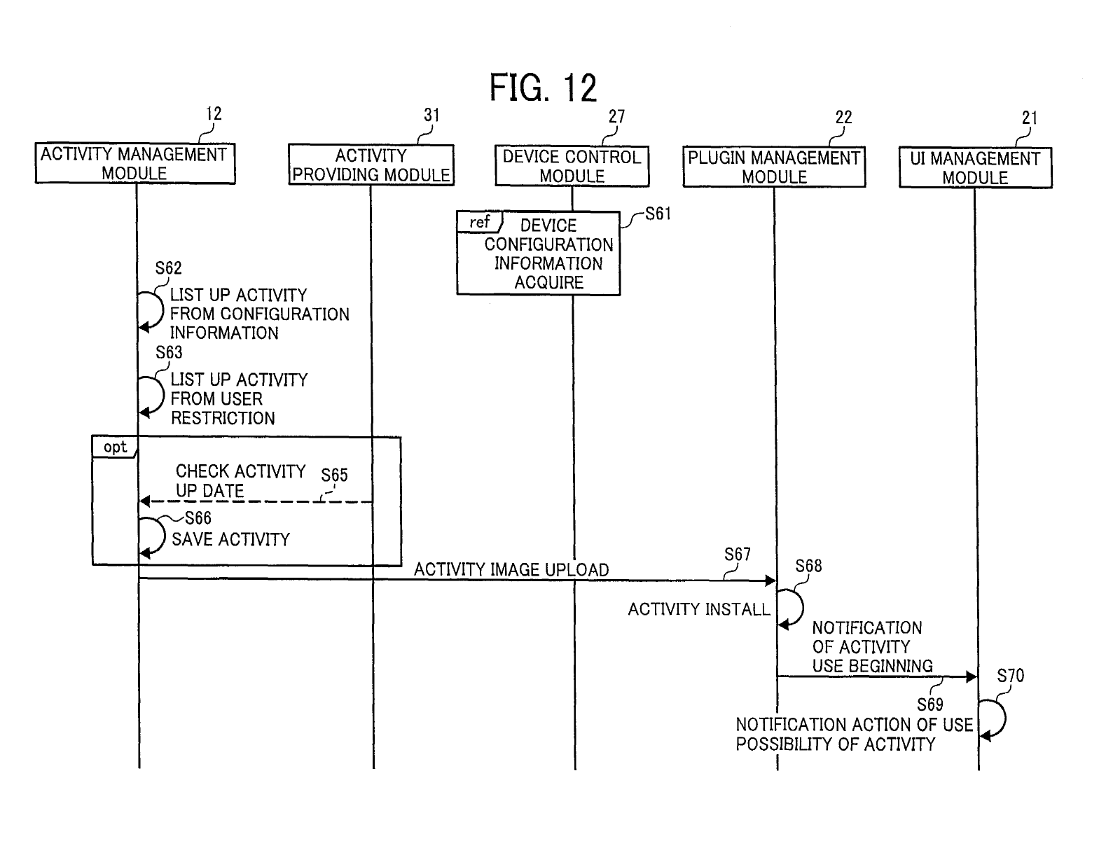

FIG. 12 is a sequence chart showing a third exemplary available activity setup process according to an embodiment of the present invention.

Since the sequence chart of FIG. 12 is the same as FIG. 10 except for some parts, an explanation about the common parts will be skipped. The sequence of steps S61˜S63, and S67˜S70 is similar to steps S51˜S53 and S56˜S59, respectively, of FIG. 10.

Referring to FIG. 12, the device management apparatus 1 acquires the activity image from the activity providing device 3, same as the embodiment shown in FIG. 10.

In addition, the activity management module 12 checks an activity update of the activity providing module 31 by sending a saving activity list inside of the activity management module 12 (S64), and acquiring the activity image from the activity providing module 31, wherein the activity image of the activity is updated inside the activity providing module 12 (S65), and the activity image is saved to the activity management module 12 (S66). The activity management module 12 may check the activity update, for example, at the time the activity management module 12 starts up.

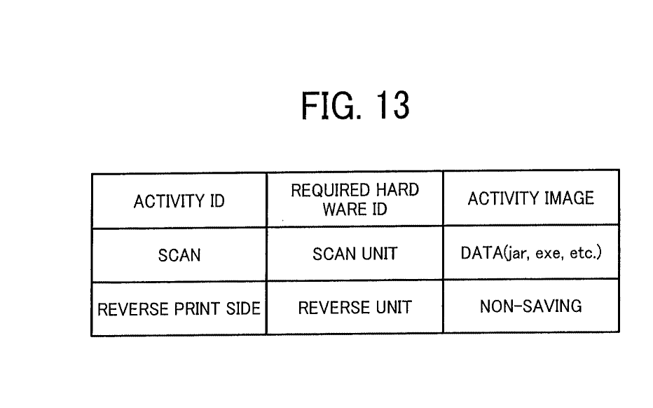

The activity management module 12 holds an activity information list such as shown in FIG. 13, which shows a third exemplary activity information list of the management apparatus, wherein the activity information list includes the same fields of the fields shown in FIG. 8. In addition, FIG. 13 shows a non-saving activity image of the activity.

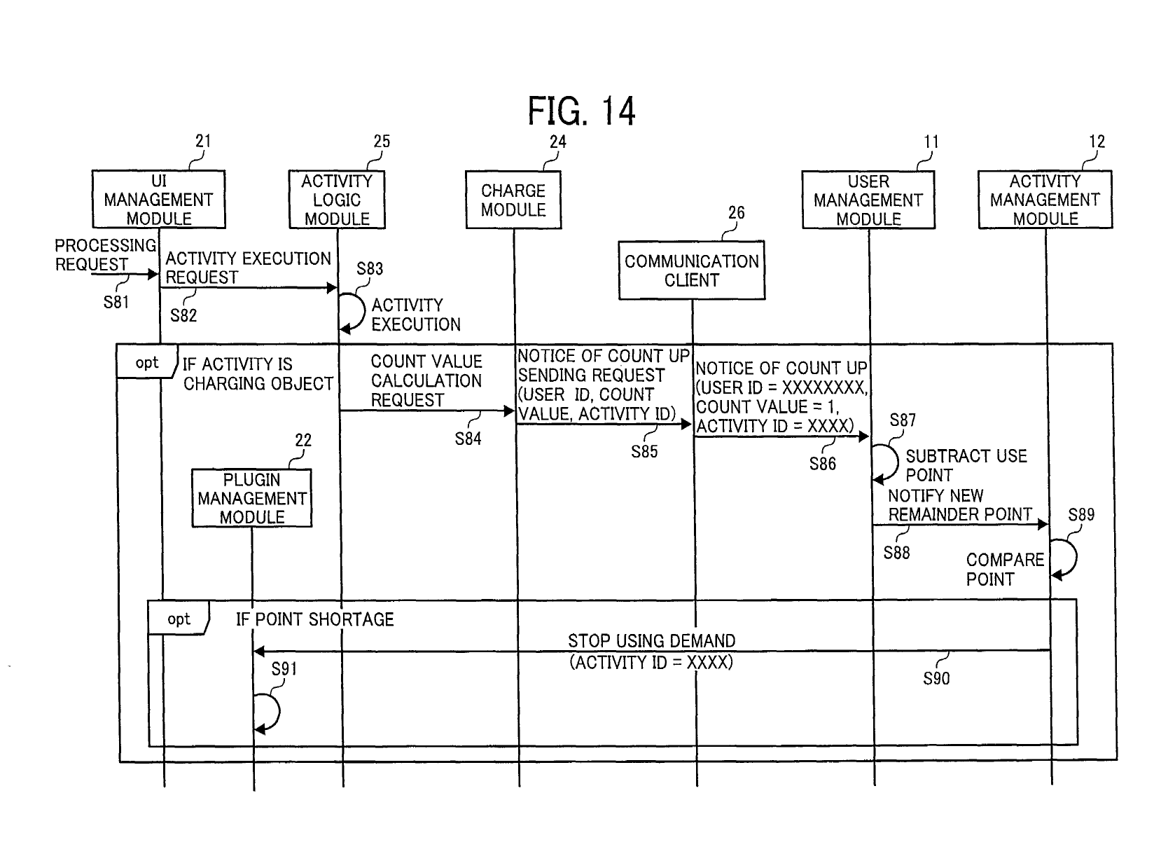

FIG. 14 is a sequence chart showing an exemplary charging process according to an embodiment of the present invention. In this embodiment, the user will be charged for the used activities to perform the scenario for the user, wherein the scenario is made up of a plurality of the activities.

Referring to FIG. 14 the UI management module 21 accepts a processing request from a user (S81). The UI management module 21 requests execution of activities making up a scenario to the activity logic module 25 (S82). The activity logic module 25 executes the activities making up the scenario (S83). If the activity executed by the activity logic module 25 is a charging activity, the sequence advances to the processing following after step S84. The activity logic module 25 requests count value calculation to the charge module 24 (S84).

The charge module 24 requests sending a notice of use to the communication client 26, wherein the notice of use may includes the user ID, a count value, and the activity ID (S85). The count value may be a use number, or a use time.

The communication client 26 sends the notice of use to the user management module 11 (S86).

The user management module 11 subtracts associated usage points of the activities to perform the scenario from a current usage (points) budget of the user (to get remainder points), wherein the associated usage points are stored in the activity management DB 17, and the new current usage budget (remainder points) is stored in the user management DB 16 (S87).

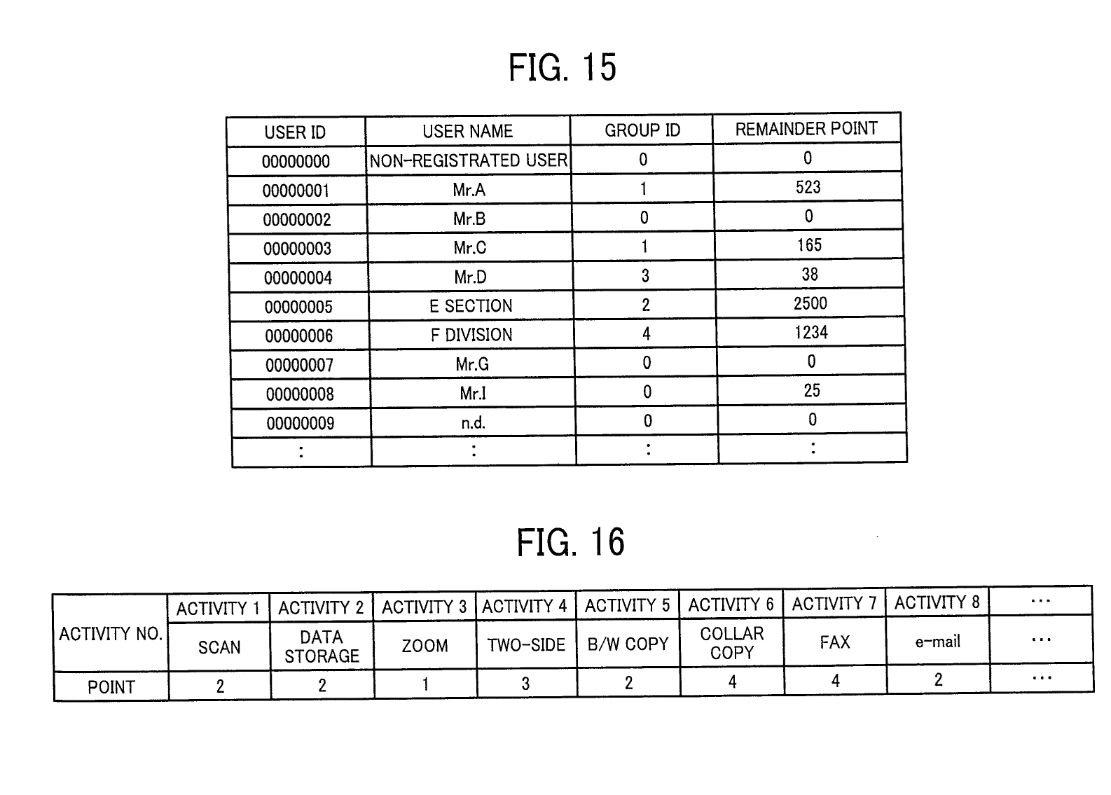

FIG. 15 is a diagram showing an exemplary use management DB 16 of the management apparatus.

Referring to FIG. 15, the use management DB 16 may include a user ID, a user name, a group ID, and remainder points (usage budget) for the user.

FIG. 16 is a diagram showing an exemplary activity management DB 17 of the management apparatus.

Referring to FIG. 16, the activity management DB 17 describes the usage points required for each activity.

Returning to FIG. 14, the user management module 11 notifies the activity management module 12 of new remainder points (S88). The activity management module 12 compares the use points of each activity with the new remainder points and examines whether there is an unavailable activity that the user can't use with the remainder points (current usage budget) (S89). When a point shortage is discovered for the activity, the activity management module 12 demands of the plugin management module 22 to stop using the unavailable activity with the activity ID (S90). The plugin management module 22 stops use of the unavailable activity (S91). According to this embodiment of the invention, the user can use each activity within the remainder points.

In addition, the device management apparatus 1 accepts a logout from a user, like the login transaction shown in FIG. 6. When the logout transaction is processed, the session management module 23 notifies the plugin management module 22 of suspension of the activity by the user.

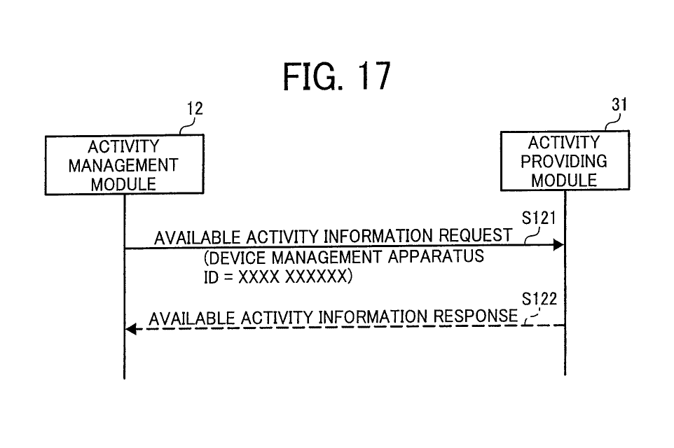

FIG. 17 is a sequence chart showing an exemplary activity information synchronous process according to an embodiment of the present invention.

Referring to FIG. 17, the activity management module 12 and the activity providing module 31 perform synchronization of the activity information. The activity management module 12 sends a request of an acquisition of information of the activities, wherein the request includes the device management apparatus ID, and the activities are available to be offered from the activity providing module 31 currently (S121). The activity providing module responds with the information to the request of the activity management module 12, wherein the information includes, for example, an activity ID, an activity version, an activity price, or a providing status indicating offered or non-offered (S122).

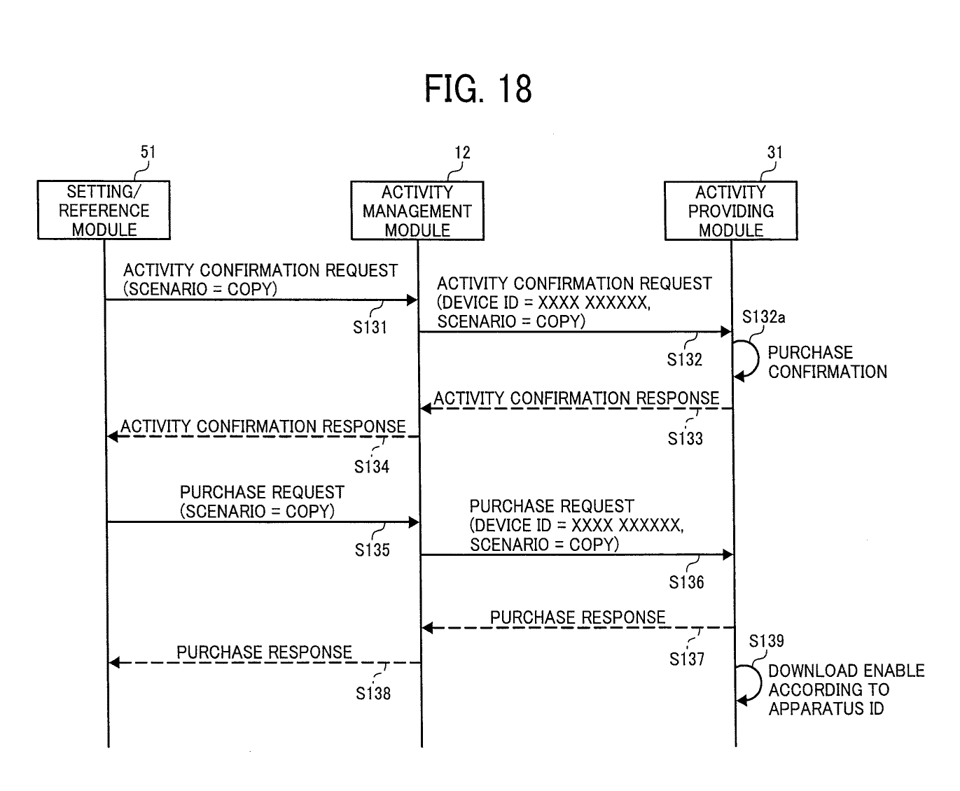

FIG. 18 is a sequence chart showing an exemplary activity purchase process according to an embodiment of the present invention.

Referring to FIG. 18, the setting/reference module 51 of the information reference/setting device 5 performs confirmation request of activity to the activity management module 12 of the device management apparatus 1, wherein the confirmation request specifies the scenario (S131). In this embodiment, a copy scenario is specified as the example of the scenario. The activity management module 12 performs confirmation request of the activity to the activity providing module 31, wherein the confirmation request specifies, for example, device management apparatus ID, and the activities that comprise the copy scenario (paper supply, print, scan) (S132).

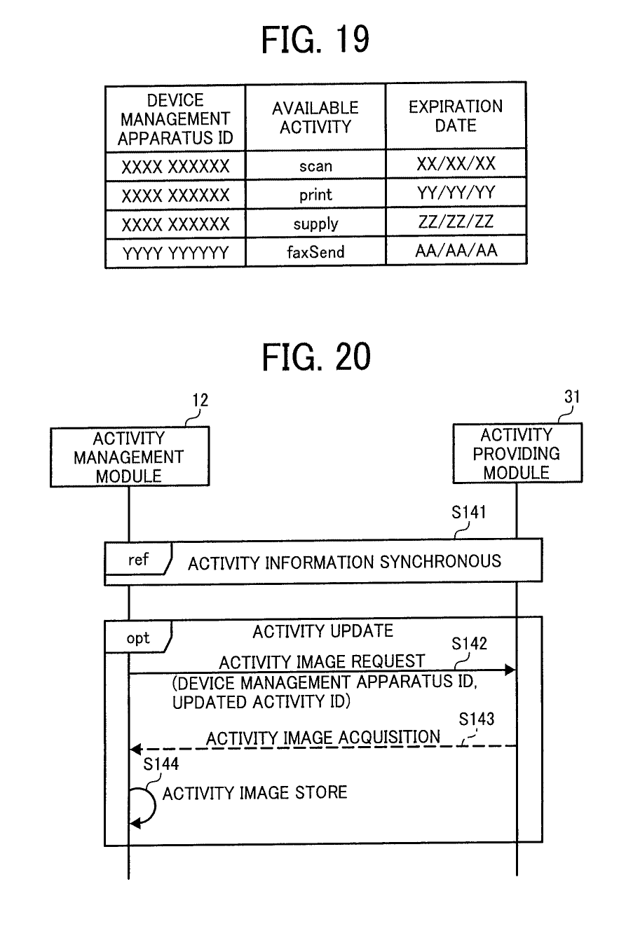

FIG. 19 is a diagram showing an exemplary certification table 32 for the activity providing device.

Referring to FIG. 19, the certification table 32 includes the device management apparatus ID corresponding to an available activity, and an expiration date, wherein the certification table 32 records activities purchased by each device management apparatus 1.

Returning to FIG. 18, the activity providing module 31 confirms whether that the activities specified by the scenario of the confirmation request is purchased or non-purchased by the device management apparatus 1, referring to the certification table 32 (S132a).

When the result is “non-purchased”, the following sequence is performed.

The confirmation result is notified from the activity providing module to the activity management module 12 (S133), from the activity management module 12 to the setting/reference module 51 (S134).

The setting/reference module 51 performs an activity purchase request to the activity management module 12 corresponding to an accept purchase request of the scenario from the user, wherein the activity purchase request specifies the copy scenario (S135). The activity management module 12 performs the activity purchase request to the activity providing module 31 (S136). The activity providing module 31 performs a purchase response of activity expressing “purchase OK” for the activity management module 12 (S137). The activity management module 12 performs a purchase response for the setting/reference module 51 (S138).

The activity providing module records the activities purchased newly to the certification table 32. After this recording, a download of the activities is enabled for a request from the device management apparatus 1 according to the device management apparatus ID (S139).

FIG. 20 is a sequence chart showing an exemplary purchased activity automatic update process according to an embodiment of the present invention.

The activity management module 12 and the activity providing module 31 perform synchronization of the activity information shown in FIG. 17 (S141). When there is updated activity among purchased activity, the sequence advances to the processing after step S142.

The activity management module 12 performs an acquisition request of the activity image including the device management apparatus ID and updated activity ID for the activity providing module 31 (S142).

The activity management module 12 acquires the non-acquisition activity image among the activities updated from the activity providing module (S143). The activity management module 12 stores the acquired activity image to the activity management DB 17 (S144).

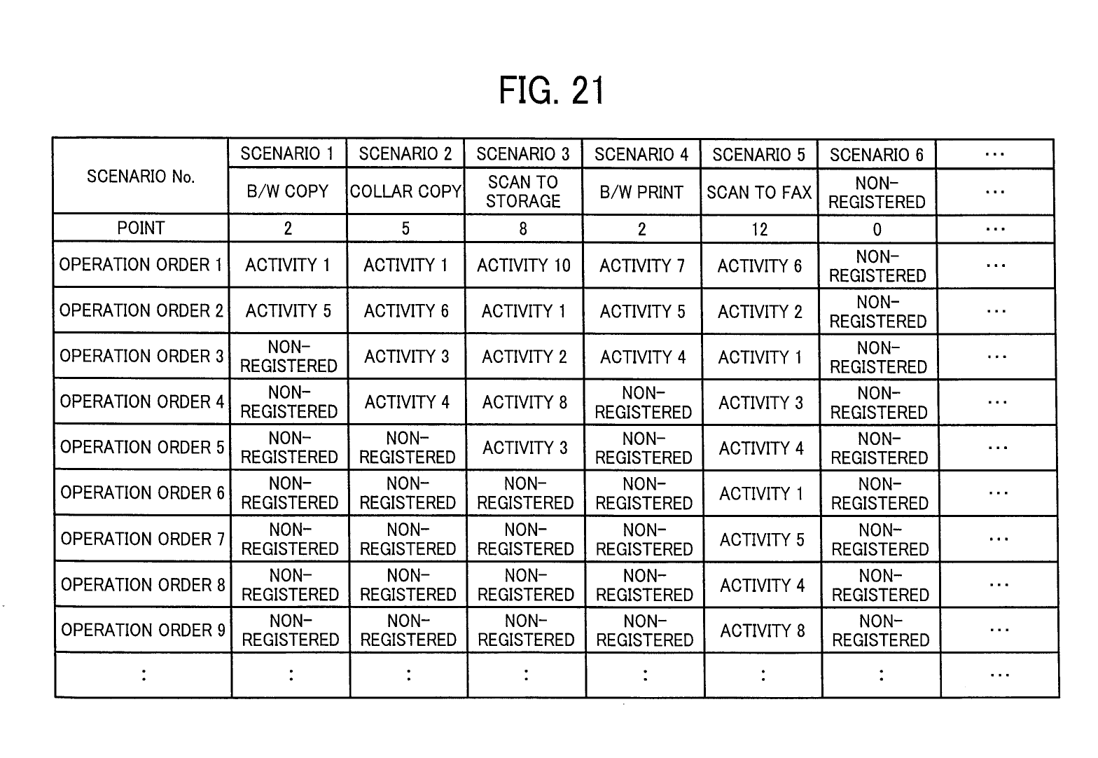

FIG. 21 is a diagram showing an exemplary scenario management DB 18 of the management apparatus.

FIG. 21 shows a scenario and activities which making up the scenario, an operation order to carry out the activities, and use points for carrying out the activities (see FIG. 16).

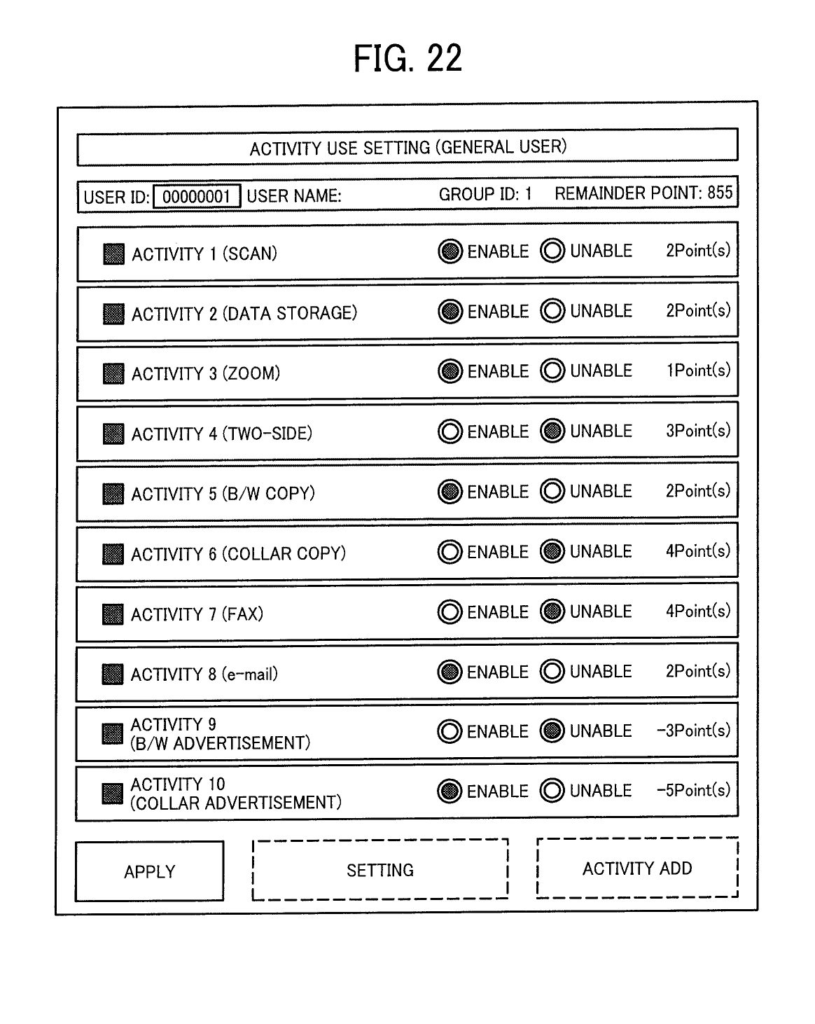

The scenario management DB 18 can be revised by a user using a UI screen, for example, shown in FIG. 22 to FIG. 27.

FIG. 22 is a diagram showing a user interface of the user interface device, for activity use setting for a general user.

Referring to FIG. 22, the user can set each activity to “enable” or “unable” by the user interface. When the user sets the activity 9 (B/W advertisement) to “enable”, the activity increases the user point 3 points for each print with an advertisement.

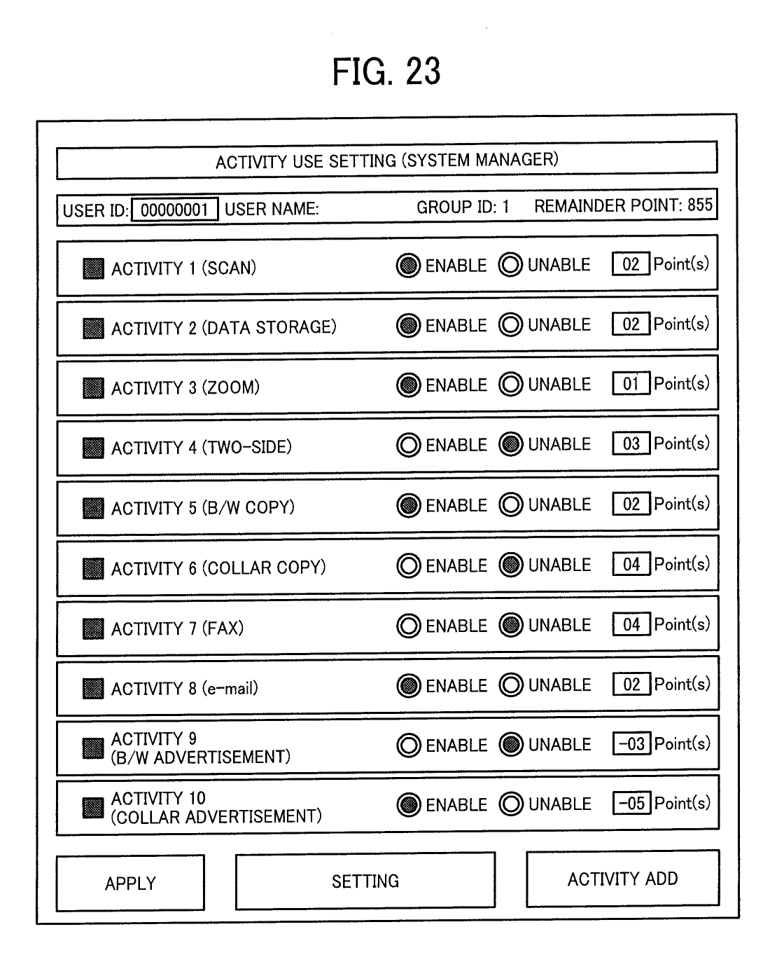

FIG. 23 is a diagram showing a user interface of the user interface device for activity use setting for a system manager.

Referring to FIG. 23, the system manager can add a new activity, and revise the setting of, for example, an indication order of activities, or use points, in addition to the general user setting.

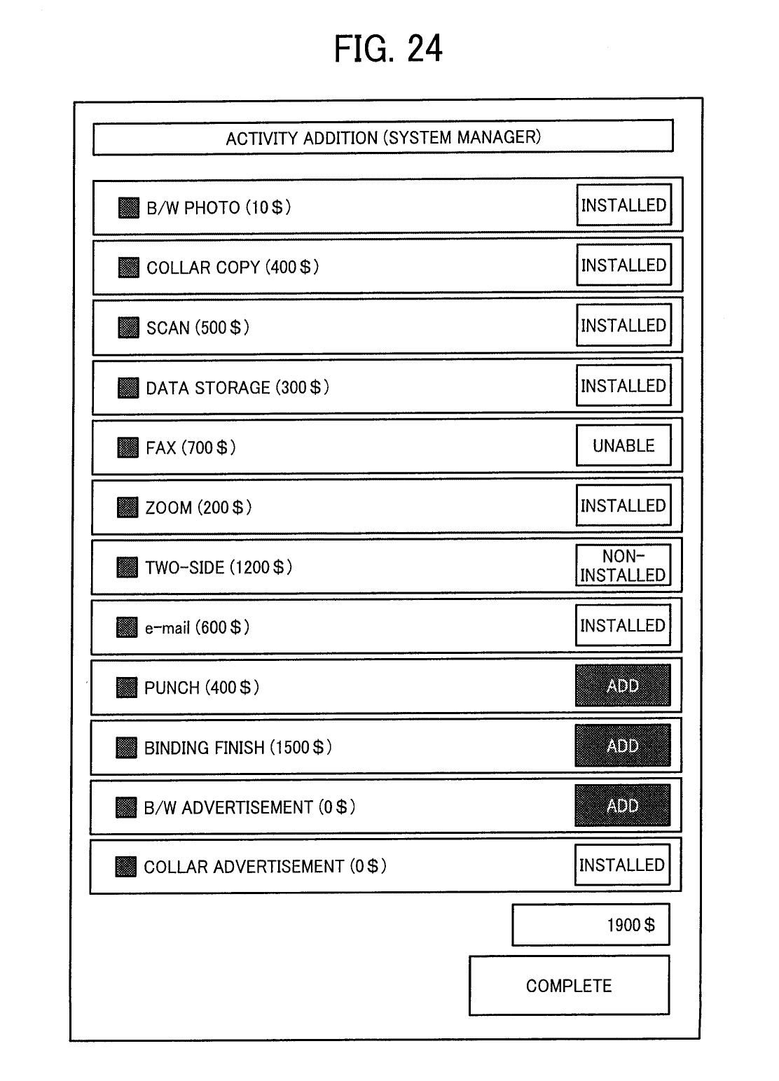

FIG. 24 is a diagram showing a user interface of the user interface device, for activity adding for a system manager.

Referring to FIG. 24, the system manager can add a new activity by pushing the “activity add” button of the user interface device shown in FIG. 23. The system manager can understand which activity is already installed, non-installed, or unable to install form the user interface. When the system manager selects adding new activities (non-installed), for example, “punch”, “binding finish”, and “B/W advertisement”, total costs are $1,900 to add new activities to the device management apparatus 1.

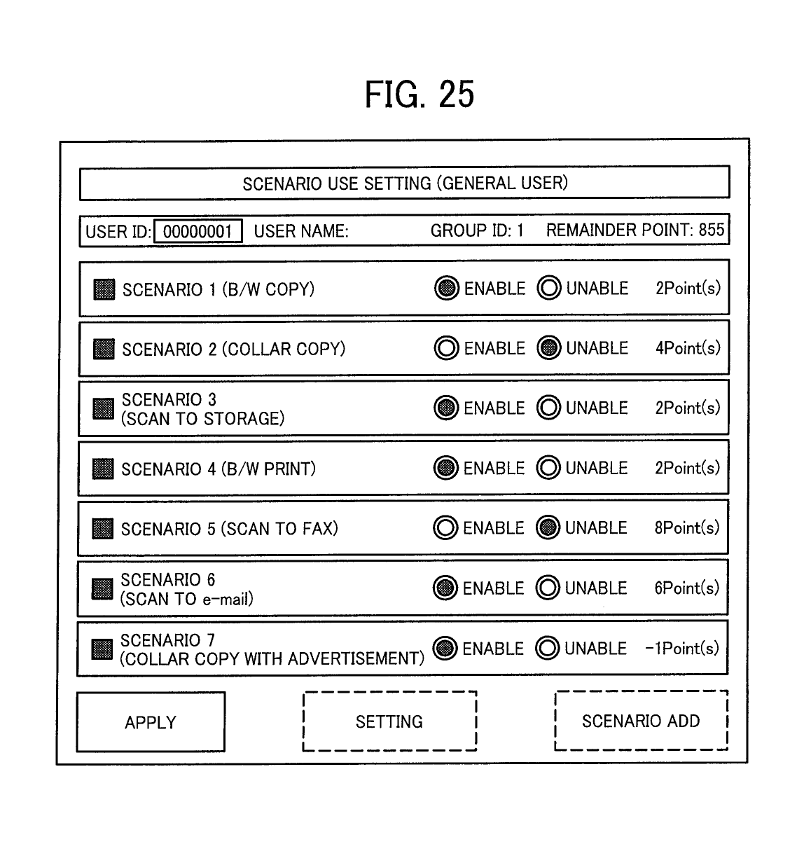

FIG. 25 is a diagram showing a user interface of the user interface device, for scenario use setting for a general user.

Referring to FIG. 25, the user can set each of the scenarios to “enable” or “unable” by the user interface.

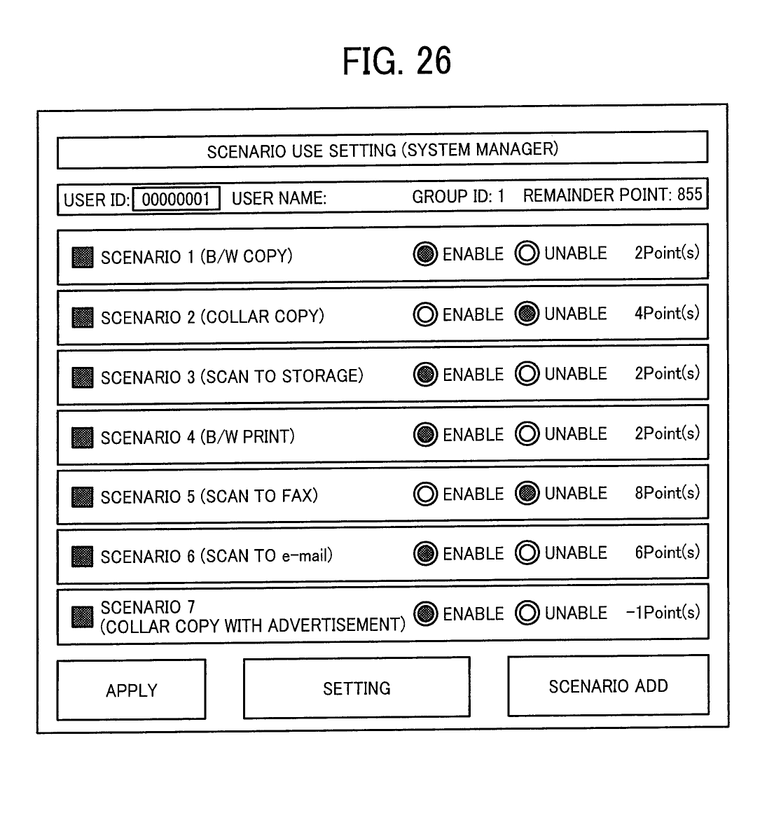

FIG. 26 is a diagram showing a user interface of the user interface device for scenario use setting for a system manager.

Referring to FIG. 26, the system manager can add a new scenario, and revise the setting of, for example, an indication order of scenario, or use points, in addition to the general user setting.

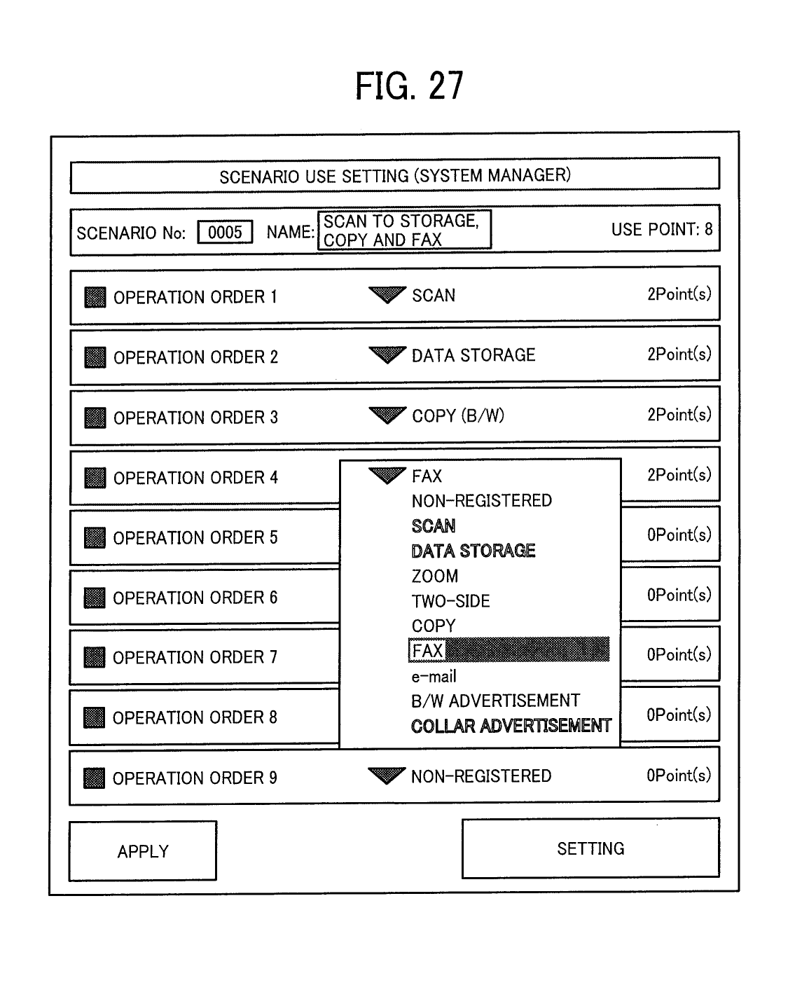

FIG. 27 is a diagram showing a user interface of the user interface device, for scenario setting for a system manager.

Referring to FIG. 27, the system manager can create a new scenario from the operation order of the activities. When arranging the activities to “scan” as operation order 1, “data storage” as operation order 2, “B/W copy” as operation order 3, and “FAX” as operation order 4, the device will work “scan to storage, to copy, and to FAX” as “scenario 0005”. This “white space background letter” showing an enabled activity in the operation order for avoiding contradictory order of the activities. For example, for the operation order 4, scan activity, data storage activity, and copy activity cannot be selected because these activities can be operated only one time, and collar advertisement activity cannot be selected because of contradiction with the B/W copy.

The use points of a scenario are set automatically by setting the use points of the activities.

According to this invention, charging management of a scenario and an activity is simplified.

1. A management apparatus for managing a plurality of functions for use in a device by a user, wherein each function has at least one functional element, the apparatus comprising:
a first memory configured to store correspondence data describing a relationship between a functional element and unit configuration information of the device, the unit configuration information indicating at least one unit of the device used by the functional element;
a second memory configured to store use authority data corresponding to the user; and
a management module configured to select an available function of the plurality of functions based on the stored correspondence data and the stored use authority data, and to send the at least one functional element corresponding to the selected function to the device.

2. The management apparatus as claimed in claim 1, wherein the management unit is configured to acquire the at least one functional element from a functional element providing module.

3. The management apparatus as claimed in claim 1, wherein the management module is configured to search for the at least one functional element in the apparatus, and to acquire the at least one functional element from a functional element providing module, when the at least one functional element is not found in the apparatus.

4. The management apparatus as claimed in claim 1, further comprising:
a user management module configured (1) to manage state information of usage of the user, the state information including a current usage budget for the user, (2) to receive usage information of the at least one functional element by the user from the device, and (3) to change the state information according to the usage information.

5. The management apparatus as claimed in claim 4, wherein the user management module is configured to check the state information, and to restrict the user using a function of the device based on the state information of the user.

6. The management apparatus as claimed in claim 4, wherein each of the at least one functional element has an associated usage cost; and
the user management module is configured to check the state information to determine whether the current usage budget of the user indicates that the user can use the selected function, based on the associated usage cost of the at least one functional element of the selected function.

7. The management apparatus as claimed in claim 1, further comprising:
an interface unit configured to provide screen data to a user interface device for setting the use authority data, and to receive the use authority data from the user interface device.

8. The management apparatus as claimed in claim 7, wherein the use authority data includes use restriction data for each of the plurality of functions and/or each of the at least one functional element.

9. The management apparatus as claimed in claim 1, further comprising:
a user management unit configured to manage user login status, wherein the at least one functional element is restricted based on the user login status.

10. A management method for controlling a management apparatus that manages a plurality of functions for use in a device by a user, wherein each function has at least one functional element, the method comprising:
storing correspondence data describing a relationship between a functional element and unit configuration information of the device, wherein the unit configuration information indicates at least one unit of the device used by the functional element;
storing use authority data corresponding to the user;
selecting an available function of the plurality of functions based on the stored correspondence data and the stored use authority data; and
sending the at least one functional element corresponding to the selected function to the device.

11. The management method as claimed in claim 10, further comprising:
acquiring the at least one functional element from a functional element providing module.

12. The management method as claimed in claim 10, further comprising:
searching for the at least one functional element in the apparatus; and
acquiring the at least one functional element from a functional element providing module, when the at least one functional element is not found in the apparatus.

13. The management method as claimed in claim 10, further comprising:
managing state information of usage of the user, the state information including a current usage budget for the user, and receiving usage information of the at least one functional element by the user from the device; and
changing the state information according to the usage information.

14. The management method as claimed in claim 13, further comprising:
checking the state information; and
restricting the user using a function of the device based on the state information of the user.

15. The management method as claimed in claim 13, further comprising:
charging an associated usage cost for use of each functional element; and
checking the state information to determine whether the current usage budget of the user indicates that the user can use the selected function, based on the associated usage cost of the at least one functional element of the selected function.

16. The management method as claimed in claim 10, further comprising:
providing screen data to a user interface device for setting the use authority data; and
receiving the use authority data from the user interface device.

17. The management method as claimed in claim 16, wherein the use authority data includes use restriction data for each of the plurality of functions and/or each of the at least one functional element.

18. The management method as claimed in claim 10, further comprising:
managing user login status, wherein the at least one functional element is restricted based on the user login status.

19. A computer readable storage medium having embodied therein program code for causing a computer to execute the management method claimed in claim 10.
